(19) United States
(12) Patent Application Publication
(10) Pub. No.: US 2026/0119175 A1
(43) Pub. Date: Apr. 30, 2026

(54) MEMORY DEVICE AND METHOD

(71) Applicants: Samsung Electronics Co., Ltd., Suwon-si (KR); Seoul National University R&DB Foundation, Seoul (KR)

(72) Inventors: Bongjun KIM, Suwon-si (KR); Bernhard EGGER, Seoul (KR); Da On PARK, Seoul (KR); Jung Yoon KWON, Seoul (KR); Ji Hong MIN, Seoul (KR); Jun Sung YOOK, Seoul (KR)

(73) Assignees: Samsung Electronics Co., Ltd., Suwon-si (KR); Seoul National University R&DB Foundation, Seoul (KR)

(21) Appl. No.: 19/232,277

(22) Filed: Jun. 9, 2025

(30) Foreign Application Priority Data
Oct. 24, 2024 (KR) 10-2024-0147031

(51) Int. Cl. G06F 9/30

(52) U.S. Cl. CPC G06F 9/30072; G06F 9/3001; G06F 9/30043

(57) ABSTRACT

A memory device includes a plurality of memory banks, and a processing-in-memory (PIM) block accessible to the plurality of memory banks, wherein the PIM block comprises a control circuit configured to receive a plurality of operation instructions from a host and, in response to a predicated instruction indicating a predication operation among the plurality of operation instructions, instruct an arithmetic logic unit (ALU) to perform the predication operation, a predicate register file (PRF) configured to store therein a predicate value determined by the predication operation, and the ALU configured to perform an operation according to a command signal translated by the control circuit based on the predicate value from an operation instruction that depends on the predicate value among the plurality of operation instructions.

### CROSS-REFERENCE TO RELATED APPLICATIONS

This application claims the benefit under 35 USC § 119(a) of Korean Patent Application No. 10-2024-0147031 filed on Oct. 24, 2024 in the Korean Intellectual Property Office, the entire disclosure of which is incorporated herein by reference for all purposes.

### BACKGROUND

### 1. Field

The following description relates to a memory device and method.

### 2. Description of Related Art

Efficient and high-performance neural network processing is important for devices such as computers, smartphones, tablets, and wearables. The processing performance increased by the decreasing power consumption of the devices enables the implementation of a hardware accelerator specific for performing a specialized task. For example, a plurality of hardware accelerators may be connected to generate a computation graph for applications such as natural language processing (NLP), language translation, and text generation. Therefore, a subsystem for accelerating NLP, language translation, and text generation may include a plurality of specialized hardware accelerators having efficient streaming interconnections for data transmission between the hardware accelerators. A near-memory accelerator may be a hardware accelerator implemented near a memory. In-memory computing (IMC) may be an implementation of a hardware accelerator inside a memory.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a memory device includes a plurality of memory banks, and a processing-in-memory (PIM) block accessible to the plurality of memory banks, wherein the PIM block comprises a control circuit configured to receive a plurality of operation instructions from a host and, in response to a predicated instruction indicating a predication operation among the plurality of operation instructions, instruct an arithmetic logic unit (ALU) to perform the predication operation, a predicate register file (PRF) configured to store therein a predicate value determined by the predication operation, and the ALU configured to perform an operation according to a command signal translated by the control circuit based on the predicate value from an operation instruction that depends on the predicate value among the plurality of operation instructions.

For the instructing of the ALU to perform the predication operation, the control circuit may include a decoder configured to load the predicate value from the PRF, and translate a predicated instruction that depends on the predicate value into the command signal based on the predicate value.

For the instructing of the ALU to perform the predication operation, the control circuit may be configured to, in response to a condition specified for performing an operation corresponding to the predicated instruction being true by the predicate value, instruct the ALU to perform either one or both of an arithmetic operation and a logical operation corresponding to the predicated instruction.

For the of instructing the ALU to perform the predication operation, the control circuit may be configured to, in response to a condition specified for performing an operation corresponding to the predicated instruction being false by the predicate value, instruct the ALU no operation (NOP) in response to the predicated instruction.

The plurality of operation instructions may include an instruction for checking a conditional statement comprised in a loop and a predicated instruction associated with the conditional statement, and, for the instructing of the ALU to perform the predication operation, the control circuit may be configured to, based on a predicate value from the checking of the conditional statement, instruct the ALU whether to perform an operation corresponding to the predicated instruction.

For the performing of the operation according to the command signal by the ALU, the PIM block may be configured to load, from the same memory bank, one or more values for the checking of the conditional statement and the operation corresponding to the predicated instruction.

The memory device may include a plurality of PIM blocks comprising the PIM block, wherein, for the performing of the operation according to the command signal by the ALU, the plurality of PIM blocks may be configured to perform, in parallel, operations according to respective iterations for which the plurality of PIM blocks are configured to perform respectively in the loop.

The PIM block may have a plurality of ALUs comprising the ALU, and the control circuit may be configured to acquire a plurality of predicate values by performing a conditional operation of each iteration in the loop by each of the plurality of ALUs, and instruct the plurality of ALUs to perform a common operation determined based on a logically merged value of the plurality of predicate values.

The control circuit may be configured to, for n conditional statements in n iterations, instruct n ALUs to determine predicate values in parallel.

The PRF may include a predicate tree circuit configured to output the logically merged value from the plurality of predicate values.

In one or more general aspects, an operating method of a memory device includes receiving a plurality of operation instructions from a host, in response to a predicated instruction indicating a predication operation among the plurality of operation instructions, instructing an arithmetic logic unit (ALU) to perform the predication operation, storing, in a predicate register file (PRF), a predicate value determined by the predication operation, and performing, by the ALU, an operation according to a command signal translated based on the predicate value from an operation instruction that depends on the predicate value among the plurality of operation instructions.

The instructing of the ALU to perform the predication operation may include loading the predicate value from the PRF, and translating a predicated instruction that depends on the predicate value into the command signal based on the predicate value.

The instructing of the ALU to perform the predication operation may include, in response to a condition specified for performing an operation corresponding to the predicated instruction being true by the predicate value, instructing the ALU to perform either one or both of an arithmetic operation and a logical operation corresponding to the predicated instruction.

The instructing of the ALU to perform the predication operation may include, in response to a condition specified for performing an operation corresponding to the predicated instruction being false by the predicate value, instructing the ALU no operation (NOP) in response to the predicated instruction.

The plurality of operation instructions may include an instruction for checking a conditional statement comprised in a loop and a predicated instruction associated with the conditional statement, and the instructing of the ALU to perform the predication operation may include instructing the ALU to perform an operation corresponding to the predicated instruction based on a predicate value from the checking of the conditional statement.

The performing of the operation according to the command signal by the ALU may include loading, from the same memory bank, one or more values for checking the conditional statement and the operation corresponding to the predicated instruction.

The performing of the operation according to the command signal by the ALU may include performing, by a plurality of processing-in-memory (PIM) blocks, operations, in parallel, according to respective iterations for which the PIM blocks are configured to perform respectively in the loop.

A PIM block of the memory device may have a plurality of ALUs comprising the ALU, and the instructing of the ALU to perform the predication operation may include acquiring a plurality of predicate values by performing a conditional operation of each iteration according to a loop via each of the plurality of ALUs, and instructing the plurality of ALUs to perform a common operation determined based on a logically merged value of the plurality of predicate values.

The instructing of the ALU to perform the predication operation may include, for n conditional statements in n iterations, instructing n ALUs to determine predicate values in parallel.

In one or more general aspects, a memory device includes a processing-in-memory (PIM) block comprising a control circuit configured to, in response to a predicated instruction indicating a predication operation among a plurality of operation instructions received from a host, generate a first instruction instructing an arithmetic logic unit (ALU) to perform either one or both of an arithmetic operation and a logical operation corresponding to the predicated instruction, and generate a second instruction instructing the ALU no operation (NOP) in response to the predicated instruction, and instruct the ALU based on either the first instruction or the second instruction, based whether a condition specified for performing an operation corresponding to the predicated instruction is true by a predicate value determined by the predication operation, and the ALU configured to perform an operation according to the instructing of the PIM block.

Other features and aspects will be apparent from the following detailed description, the drawings, and the claims.

### BRIEF DESCRIPTION OF THE DRAWINGS

FIG. 1 illustrates an example of a computing system according to one or more example embodiments.

FIG. 2 illustrates an example of a processing-in-memory (PIM) block of a memory device according to one or more example embodiments.

FIG. 3 illustrates an example configuration of a PIM block according to one or more example embodiments.

FIG. 4 illustrates an operating method of a memory device according to one or more example embodiments.

FIGS. 5 and 6 illustrate an example of how a PIM block processes a predicated operation according to one or more example embodiments.

FIG. 7 illustrates an example of how a PIM block processes a predication operation of a graph traversal algorithm according to one or more example embodiments.

FIG. 8 illustrates an example of how a PIM block determines and logically merges predicate values in parallel via a plurality of arithmetic logic units (ALUs) and performs a common operation based on a merged predicate value, according to one or more example embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as “on,” “connected to,” “coupled to,” or “joined to” another component, layer, or element, it may be directly (e.g., in contact with the other component, element, or layer) “on,” “connected to,” “coupled to,” or “joined to” the other component, layer, or element, or there may reasonably be one or more other components, layers, or elements intervening therebetween. When a component, layer, or element is described as “directly on,” “directly connected to,” “directly coupled to,” or “directly joined to” another component, layer, or element, there can be no other components, layers, elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, examples will be described in detail with reference to the accompanying drawings. When describing the examples with reference to the accompanying drawings, like reference numerals refer to like components and a repeated description related thereto is omitted.

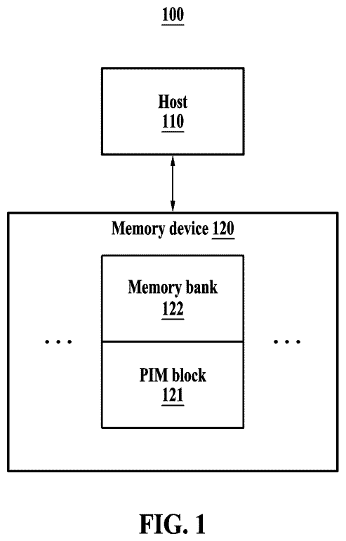

FIG. 1 illustrates an example of a computing system according to one or more example embodiments.

A computing system 100 of one or more embodiments may include a host 110 and a memory device 120. As non-limiting examples, the computing system 100 may be an electronic device such as a computer, a smartphone, a tablet, and/or a wearable electronic device.

The host 110, which is a main management entity of a computing system (e.g., an electronic device), may be implemented as a host processor (e.g., one or more processors) or a server. The host processor may include, for example, a host central processing unit (CPU). The host processor may include, for example, a processor core and a memory controller. The memory controller may control the memory device 120. The host processor may process, via the processor core, data received from the memory device 120 via the memory controller. The memory controller may also transmit commands and/or instructions to the memory device 120.

An operation instruction is primarily described herein as an example of an instruction transmitted to the memory device 120. The operation instruction may be, for example, an instruction that instructs the performance or execution of an operation (e.g., dot product and/or value comparison). As will be described in examples later, based on the operation instruction, a processing-in-memory (PIM) block 121 of the memory device 120 may load a value recorded in a memory bank 122 of the memory device 120 and/or a register file and perform an operation using the loaded value. Of note, the operation instruction may include a dynamic random-access memory (DRAM) command provided to the memory device 120 set in a PIM all-bank mode. The operation instruction may also include information (e.g., address information) indicative of an internal address of the memory device 120.

The memory device 120 may include a memory region in which data is stored. The memory region may represent a region (e.g., a physical region) on a memory chip of the memory device 120 from an/or in which data is read and/or written. The memory region may be disposed on a memory die (or core die) of the memory device 120. The memory device 120 may communicate and cooperate with the host processor to process data in the memory region. For example, the memory device 120 may perform operations or processing on data based on a command or instruction received from the host processor. The memory device 120 may control the memory region in response to the command or instruction received from the host processor. The memory device 120 may be separate from the host processor. Of note, the host processor may be responsible for (e.g., configured to perform) overall operation (or computation) and may delegate an operation (or computation) to be performed with acceleration (e.g., PIM) to the memory device 120.

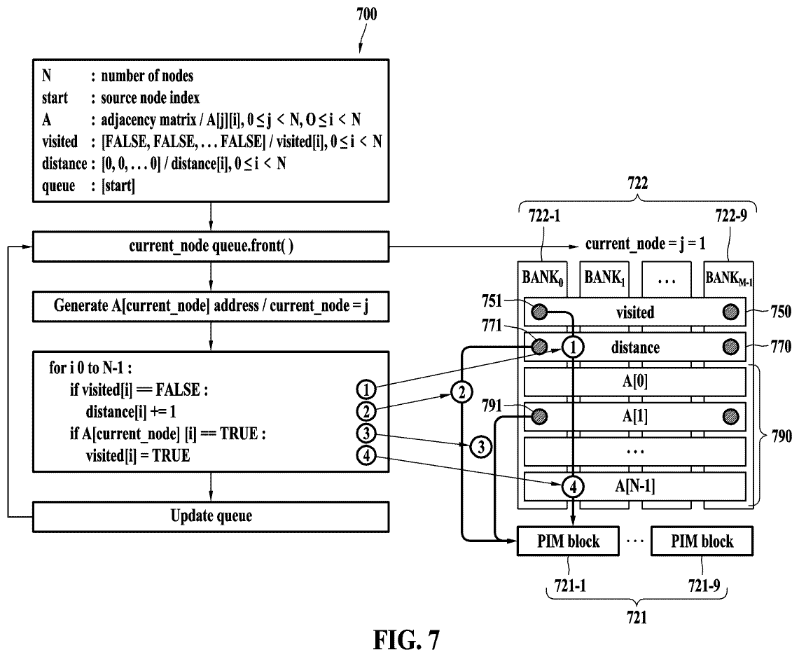

The memory device 120 of one or more embodiments may include the PIM block 121 and a memory (e.g., a plurality of memory banks 122). For example, the memory device 120 may perform a target operation using data stored in the memory via a plurality of PIM blocks. The target operation may include a plurality of partial operations. For example, as will be described in an example later with reference to FIG. 7, in a case where the target operation is an operation for a graph traversal algorithm, the target operation may include a comparison operation of comparing values and an addition operation of adding values, among operations for the graph traversal algorithm. Of note, vectors and matrices for graph traversal may have a capacity (e.g., a memory size) greater than a cache size of the host 110, and may thus be distributed and stored in a plurality of memory banks 122 of the memory device 120 (e.g., a DRAM device).

The memory may store data. The plurality of memory banks 122 may be generated using a portion or entirety of the memory chip of the memory device 120. As described herein, each of the plurality of memory banks 122 may store values (e.g., element values of a vector) to be used in the target operation or some of the values (e.g., some of the element values of the vector). For example, the target operation may be decomposed into a plurality of partial operations, and each memory bank 122 may store some data to be used in a partial operation among the plurality of partial operations. The memory device 120 and/or the host 110 may divide values to be used in the target operation and store them in the plurality of memory banks 122. Each memory bank 122 may include a plurality of storage cells that store values in a memory array disposed on the memory die of the memory device 120. The plurality of storage cells may be arranged along row lines and column lines. A portion of a memory bank 122 that includes storage cells arranged along a row line may be referred to as a memory row. The memory row may be a group of storage cells arranged along the same row line. Similarly, a memory column may be a group of storage cells arranged along the same column line.

The PIM block 121 may perform an operation using data stored in the memory according to an operation instruction. Each PIM block 121 may perform some operations (e.g., a comparison operation and an addition operation) of a plurality of partial operations included in a target operation (e.g., an operation for a graph traversal algorithm). For example, the PIM block 121 may access a memory bank 122 disposed near the PIM block 121 itself among the plurality of memory banks of the memory device 120. The PIM block 121 may acquire data of a portion corresponding to the operation instruction from the accessible memory bank 122. The PIM block 121 may perform a partial operation using the acquired data. For example, the PIM block 121 may perform the partial operation using a value corresponding to the operation instruction among values stored in the memory bank 122 accessible by the PIM block 121. The PIM block 121 may load the value corresponding to the operation instruction and perform the comparison operation and/or the addition operation using the loaded value.

It is to be noted that, although an example where the PIM block 121 is assigned to one memory bank 122 on the core die is illustrated in FIG. 1, examples are not limited thereto. The PIM block 121 may be disposed near a plurality of memory banks (e.g., two memory banks) to be accessible thereto. The PIM block 121 may perform an operation corresponding to an operation instruction via a combination of a plurality of arithmetic logical units (ALUs) (e.g., including a multiplier and an adder).

The instructions described herein may include instructions for executing operations of the host processor, the memory device 120, or processors of various devices, and/or instructions for executing operations of the respective components or configurations of processors. For example, instructions (or programs) executable by the host processor may be stored in another memory device 120, but examples are not limited thereto. For example, the other memory device 120 may include a non-transitory computer-readable storage medium storing instructions, that, when executed by the host processor, configure the host processor to perform any one, any combination, or all of operations and/or methods performed by the host processor.

The memory device 120 (e.g., a PIM device) including the PIM block 121 may perform an operation for accelerating an application program (e.g., machine learning and big data) that consumes a large memory bandwidth. The memory device 120 may perform an operation by accessing a plurality of memory banks in parallel via a plurality of PIM blocks 121. The memory device 120 may perform an operation with an internal memory bandwidth that is higher than an external memory bandwidth. Therefore, the memory device 120 of one or more embodiments may significantly reduce an execution time to be used for executing a memory-intensive application program. The memory device 120 of one or more embodiments may also move data only between the PIM block 121 and the memory bank 122 and may thus reduce power consumption.

According to one or more embodiments, a memory device (e.g., the memory device 120) may process a predicated operation as a PIM operation. A PIM hardware-based application may be expanded to a high-performance and scientific computational task. In this case, performing or executing the predicated operation (e.g., predicated execution) may turn control dependency into data dependency. As will be described in examples later, the predicated operation may be an operation that depends on a predicate value, and an operation to be performed may vary depending on the predicate value. Using the predicated execution may allow a divergent branch in the code not to handle a jump instruction, but instead, to execute a specific instruction or generate a predicate value(s) for skipping. This execution method of one or more embodiments may not require a complex hardware implementation compared to a typical jump instruction and a branch prediction. The predicated execution by the memory device of one or more embodiments described in examples later may be more advantageous when both branches include fewer instructions or code lines. The memory device of one or more embodiments may exhibit improved performance without a need for the jump instruction or complex branch prediction. The memory device of one or more embodiments may also efficiently support workloads into which a control flow is branched while using a single instruction, multiple threads (SIMT) execution model. The memory device of one or more embodiments may thus support most data analytics workloads (e.g., big data, bioinformatics, and graph processing) that involve multiple “if-else” or “break” statements in algorithms.

For example, a PIM block of the memory device may include a predicate register file (PRF) that physically stores predicate values for realizing predicate-based operations. The PIM block may support an instruction set for the predicated execution. The instruction set may include, for example, an instruction for determining and storing a predicate value and an instruction for fetching the predicate value. The memory device may also perform an operation in which multiple execution branches are merged based on a result of merging predicate values.

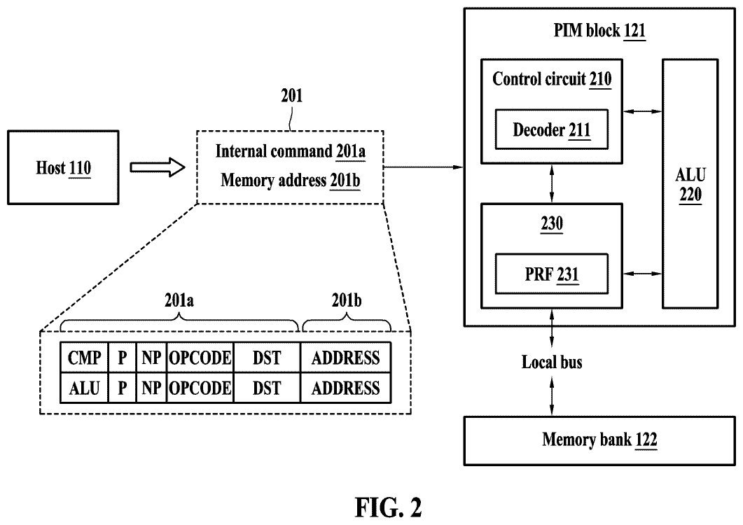

FIG. 2 illustrates an example of a PIM block of a memory device according to one or more example embodiments.

A PIM block 121 of one or more embodiments may include a control circuit 210, an ALU 220, and register files 230 (e.g., a PRF 231). As described above, the PIM block 121 may be disposed near a corresponding memory bank 122 among a plurality of memory banks of a memory device 120. The PIM block 121 may access the memory bank 122 nearby via a local bus.

The control circuit 210 may receive an operation instruction 201 from a host 110. The operation instruction 201 may include address information (e.g., a row address and a column address of a memory) that indicates a location at which a value is stored within the memory bank 122 of the memory device 120, as described above. In addition, the control circuit 210 may include a decoder 211 that processes the received operation instruction 201.

The decoder 211 may translate the received operation instruction 201 into a command signal. The command signal may also be referred to as a control signal or an operation signal. The decoder 211 may transmit the command signal to the ALU 220. The command signal may be a signal that causes or configures, in response to the ALU 220 receiving the signal, the ALU 220 to perform or execute a specific operation using a value recorded at a specific location and may include an operation identifier (or operation code). As will be described in examples later, the decoder 211 may translate a predicated operation instruction into a command signal based on a predicate value. The same operation instruction may be translated into different command signals based on a predicate value.

The predicated operation instruction may refer to an instruction for executing a predicated operation. For example, i) the predicated operation instruction may include an index field (e.g., a predicate register index field) indicating a register of the PRF 231 in which a predicate value is recorded, or ii) the predicated operation instruction itself may explicitly include the predicate value. In a case where the predicated operation instruction includes the predicate register index field, the control circuit 210 (e.g., the decoder 211) may load the predicate value from the register of the PRF 231 indicated by the predicate register index field. As will be described in examples later, the control circuit 210 (e.g., the decoder 211) may translate, based on the predicate value, an operation instruction (e.g., the predicated operation instruction) into a command signal to perform an operation or a command signal indicating no-operation (NOP). For example, in a case where, in a branch control flow, a predication condition is false (e.g., when the predication condition is not satisfied), an operation instruction may be translated by the control circuit 210 into NOP, and an unnecessary operation may thus be skipped in a corresponding execution flow.

The register files 230 may each be a device including a logic circuit (e.g., a digital logic circuit) that implements storage functionality. The register files 230 may include the PRF 231. The PRF 231 may store predicate values. The predicate values stored or recorded in the PRF 231 may be used by the decoder 211 to translate predicated operation instructions into command signals, as described above. The predicate values may be determined by the ALU 220 under instruction or indication by the control circuit 210 (e.g., the decoder 211). When a memory device (e.g., the memory device 120) of one or more embodiments is implemented with a SIMT operation, each PIM block 121 of the memory device may include the PRF 231 that records therein one or more predicate bits. The size of the PRF 231 may vary depending on an implementation of the PIM block 121. For example, the number of bits that the PRF 231 may store may be greater than or equal to the number of values handled by the PIM block 121 for a single issued instruction. In a case where the PIM block 121 handles 256 values for a single instruction, the PRF 231 may be implemented with at least 256 bits. That is, the PRF 231 may record 256 predicate values.

Although an example where the PRF 231 records predicate values is primarily described herein, examples are not limited thereto. In a case where the PIM block 121 includes a plurality of register files 230, other register files, in addition to the PRF 231, may also be used for the predicated execution. For example, in a case where the PIM block 121 includes a scalar register file (SRF) for a general matrix multiply (GeMM) operation, the PIM block 121 may secondarily use an unused register file among SRFs for a deeper predicated execution. In a case where more predicated executions are to be performed than the predicated execution supported by the PRF 231, the PIM block 121 may secondarily record predicate values in some of the SRFs.

The ALU 220 may perform an arithmetic logic operation of a partial operation, under the control of the control circuit 210 (e.g., the decoder 211). For example, the ALU 220 may include a digital circuit for determining an arithmetic operation including addition, subtraction, and multiplication and/or a digital circuit for determining a logical operation including exclusive disjunction (or exclusive or (XOR)), logical conjunction (or logical AND), and logical disjunction (or logical OR). However, examples are not limited thereto, and the ALU 220 may also include a combination of digital circuits having a multiply and accumulate (MAC) operation and/or a modulo operation. The ALU 220 may load a value (e.g., an operand) recorded in an address indicated by the operation instruction 201 and perform an operation indicated by a command signal using the loaded value. The operand may be transmitted from the memory bank 122 to the ALU 220 via a data bus.

The ALU 220 may also perform an operation (e.g., a predication operation) according to a predication instruction. The predication operation may refer to an operation that generates a predicate value (e.g., a predicate bit), which may generate a predicate value and store the generated predicate value in the PRF 231. An instruction for the predication operation (e.g., a predication operation instruction) may include fields for three pieces of information. For example, the predication operation instruction may include two source fields indicative of two values for comparison and one destination field indicative of a destination predication register. However, the predication operation instruction is not limited to the preceding example, and predication operation may be realized by a typical ALU instruction. For example, a predication operation instruction based on the typical ALU instruction may include an additional predication set bit indicating whether to store in a predication register and a destination predication register index indicating where a result (e.g., a predicate bit value) is stored.

Of note, although an example where the ALU 220 uses values recorded in the memory bank 122 is primarily described herein, examples are not limited thereto. The operation instruction 201 may include information indicative of a storage (e.g., the memory bank 122 or register file) in which a value is stored and an address indicative of a location in the storage at which the value is recorded. For example, in a case of an operation using a value stored in the memory bank 122, the operation instruction 201 may include information indicative of the memory bank 122 and row and column addresses in the memory bank 122 at which the value is recorded. For another example, in a case of an operation using a value stored in a register file (e.g., a global register file (GRF)), the operation instruction 201 may include information indicative of the register file and an address of a register in the register file in which the value is recorded.

In one or more embodiments, of a target operation (e.g., an operation for a graph traversal algorithm), a partial operation (e.g., a comparison operation and an addition operation using values stored in a bank) corresponding to the memory bank 122 may be assigned to the PIM block 121 of the memory device 120. This is because the PIM block 121 may only be accessible to the memory bank 122 nearby (e.g., nearest) in the memory device 120. An example of this is described in more detail below with reference to FIG. 7.

The operation instruction 201 shown in FIG. 2, which is provided as an example of an operation instruction, may include an internal command 201a and a memory address 201b. The internal command 201a may include a predication flag field (P), a negative predication flag field (NP), an operation identifier field (OPCODE), and a destination field (DST).

The predication flag field P may be a field indicating that an operation is to be performed when a predication condition is true. For example, the predication flag field P may include a value of 1 when a predication flag is enabled, and the predication flag field P may include a value of zero (0) when the predication flag is disabled. When the predication condition is x>10 and the predication flag is enabled, a specific operation may be performed in response to x being greater than 10. Conversely, in response to x being less than or equal to 10, the specific operation for the predication condition may not be performed. In an example, x may be a value (e.g., an operand) initiated by a source field included in the predication operation instruction (e.g., a value of an element of a memory array disposed on the memory die of the memory device 120).

The negative predication flag field NP may be a field indicating that an operation is to be performed when negation (e.g., NOT) of a predication condition is true. For example, the negative predication flag field NP may include a value of 1 when a negative predication flag is enabled, and the negative predication flag field NP may include a value of 0 when the negative predication flag is disabled. When the predication condition is x>10, a negative predication condition may be the opposite, e.g., x≤10. When the predication condition is x>10 and the negative predication flag is enabled, a specific operation may be performed in response to x being less than or equal to 10. Conversely, in response to x being greater than 10, the specific operation for the negative predication condition may not be performed.

As described above, the predication condition and the negative predication condition are logical negations, but the predication flag field P and the negative predication flag field NP may be distinguished as separate fields. This is because predicated operations may be assigned to different ALUs 220 even in the same PIM block 121. In a case where there is no negative predication flag field NP, a branch prediction may be used to prepare an instruction for a first execution branch or a second execution branch, depending on whether the predication condition is true or false. In this case, when the branch prediction fails, a typical PIM block may need to prepare the instruction by returning to a correct execution flow, which may degrade the performance.

For example, a first operation to be executed when the predication condition is true may be assigned to a first ALU 220, and a second operation to be executed when the negative predication condition is true may be assigned to a second ALU 220. When the predication condition is true (e.g., the first execution branch), the first ALU 220 may perform the first operation and the second ALU 220 may be given NOP. Conversely, when the predication condition is false, e.g., when the negative predication condition is true (e.g., the second execution branch), the first ALU 220 may be instructed NOP and the second ALU 220 may perform the second operation. In one or more embodiments, the PIM block 121 of one or more embodiments may prepare, in parallel, an instruction for the first execution branch when the predication condition is true and an instruction for the second execution branch when the predication condition is false via the predication flag field P and the negative predication flag field NP, and may perform an operation according to an instruction, thereby improving performance compared to the typical PIM block that must prepare the instruction by returning to a correct execution flow in response to the branch prediction failing.

The operation identifier field OPCODE may be a field in which an identifier indicative of an operation corresponding to an instruction is recorded. For example, an operation identifier (e.g., operation code) may be an identifier indicative of an operation type among various operation types including, for example, addition, subtraction, multiplication, exclusive disjunction (or exclusive or (XOR)), logical conjunction (or logical AND), and logical disjunction (or logical OR).

The destination field DST may be a field indicative of a destination in which a result of an operation is to be stored. For example, a value indicative of one of various memory types including register files 230 and memory banks 122 may be recorded in the destination field DST.

In addition, address fields may be fields where various addresses (e.g., 201b) associated with operations, for example, a predicate address, an operand address, and a destination address, are recorded.

The predicate address may be an address indicative of a location at which a predicate value is or is to be recorded. The predicate address may be used to fetch a predicate value or access a predicate value. As described above, in a case where a predicate value is stored in the PRF 231, the predicate address may indicate a location of any one of registers in the PRF 231. However, examples are not limited thereto, and in a case where a predicate value is stored in another register file (e.g., an SRF), the predicate address may also indicate a location of any one of registers in the register file.

The operand address may be an address indicative of a location at which a value used in an operation according to an operation identifier described above is recorded. For example, in a case where an operand is stored in a memory bank 122 near the PIM block 121, the operand address may indicate a location in that memory bank 122 at which the operand is recorded. For another example, in a case where an operand is stored in a register file (e.g., a GRF) in the PIM block 121, the operand address may indicate a register in the register file in which the operand is recorded.

In one or more embodiments, the operation instruction 201 may include a predicate address (e.g., a PRF index) for a predication instruction or a predicated instruction. As described above, the predication instruction may refer to an instruction that instructs the execution of an operation of generating a predicate value. The predicated instruction may refer to an instruction that instructs the execution of an operation that is different based on a predicate value generated according to a predication operation (e.g., the execution of a specific operation or NOP).

For example, in the predication instruction, the predicate address may indicate a location at which a predicate value determined according to a predication operation is to be stored. The predication instruction may include a value indicative of the PRF 231 in the destination field DST. Therefore, the predicate value determined according to the predication instruction may be stored in a register indicated by the predicate address in the PRF 231. FIG. 2 illustrates, as an example of the predication instruction, a comparison (CMP) instruction indicative of a comparison operation.

For another example, in the predicated instruction, the predicate address may indicate a location at which a predicate value that is to be referred to for determining an operation to be performed is stored. In the operation according to the predicated instruction, a value stored in a register indicated by the predicate address in the PRF 231 may be loaded as the predicate value. FIG. 2 illustrates, as an example of the predicated instruction, an ALU instruction.

Although an example where each operation instruction (e.g., 201) includes the predicate address has been primarily described above, examples are not limited thereto. Each operation instruction 201 may also include a predicate value (e.g., a predicate bit) itself. In this case, the predicated instruction may include a predicate value determined according to a predication operation.

Also, the predication operation itself may be predicated. For example, in a case of a nested “if-else” statement (where there is an additional “if-else” statement in an “if-else” statement), whether to execute a predication operation for a predication condition of the if-else statement inside may be determined based on a predicate value determined for the if-else statement outside.

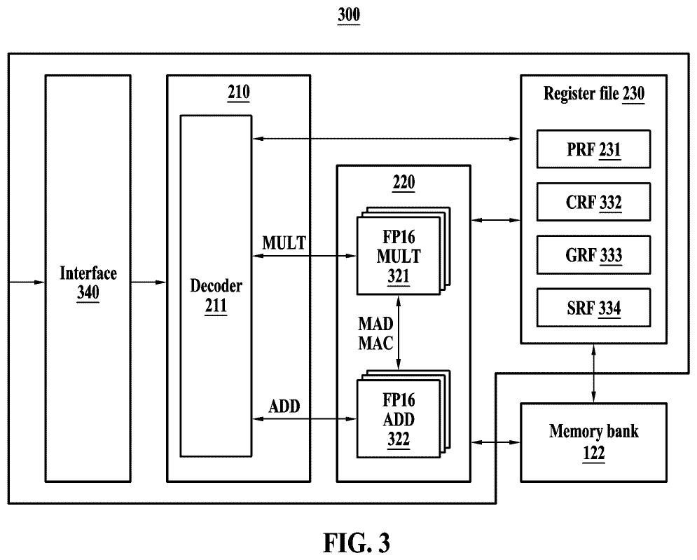

FIG. 3 illustrates an example configuration of a PIM block according to one or more example embodiments.

A PIM block 300 of one or more embodiments may include an interface 340, a control circuit 210, an ALU 220, and register files 230. As described above, the PIM block 300 may be accessible to one or more memory banks 122. The PIM block 300 may read data from the memory banks 122 and may store data in the memory banks 122, via a local bus. The PIM block 300 may also store the read data in a register file (e.g., a GRF 333) and may use a value stored in the register file for a subsequent operation.

The interface 340 may interface with a host. For example, the interface 340 may transmit, to the control circuit 210, an operation instruction received from the host.

The register files 230 may include various types of register files. For example, in the example shown in FIG. 3, the register files 230 may include a PRF 231, a control register file (CRF) 332, a GRF 333, and an SRF 334. The PRF 231 may store predicate values, as described above. A predicate value may be generated by a predication operation (e.g., a CMP operation and/or a TEST operation by the ALU 220). Of note, the CMP operation may refer to an operation of comparing two operands (e.g., a first operand and a second operand) by subtracting the second operand from the first operand, and the TEST operation may refer to an AND operation between the first operand and the second operand. The CRF 332 may refer to a register file that stores operation instructions received from the host. The GRF 333 may store global data. The SRF 334 may store scalar values.

The control circuit 210 may include a decoder 211. The decoder 211 may translate a received operation instruction into a command signal for the ALU 220. The decoder 211 may read operation instructions received from the host and stored in the CRF 332 and translate each of the operation instructions into a command signal. The control circuit 210 may orchestrate data movement based on the command signal generated by the decoder 211. For example, in a case where an operation instruction uses two source operands, the control circuit 210 (e.g., the decoder 211) may transmit one operand to the ALU 220 from the GRF 333, and may transmit the other operand by transmitting data loaded from a memory bank 122 directly to the ALU 220 via the local bus. The decoder 211 may access a source operand or a destination operand used to execute an operation corresponding to an operation instruction, based on addresses included in the operation instruction.

The decoder 211 may also access the register files 230 to fetch a predicate value that is to be referred to for executing a predicated operation. Based on the predicate value, the decoder 211 may translate the operation instruction into a command signal that instructs the execution of a specific operation or a command signal that indicates NOP.

The ALU 220 may include, for example, floating-point units (FPUs). For example, the ALU 220 shown in FIG. 3 may include an FP16 multiplier 321 and an FP16 adder 322. The FPUs may operate in parallel. Of note, the configuration of the ALU 220 is not limited to the one shown in FIG. 3.

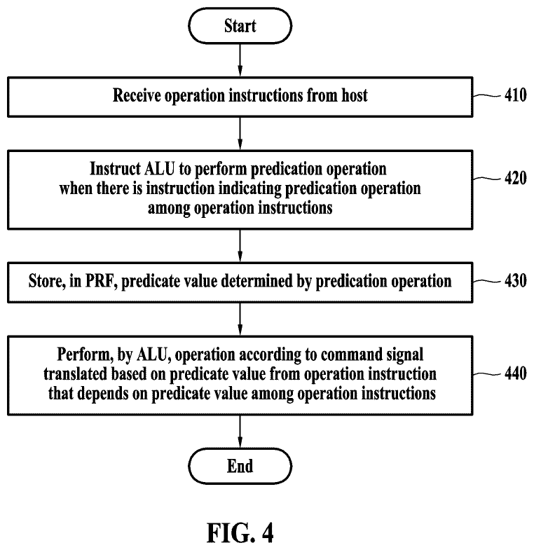

FIG. 4 illustrates an operating method of a memory device according to one or more example embodiments. Steps 410 to 440 to be described hereinafter may be performed sequentially in the order and manner as shown and described below with reference to FIG. 4, but the order of one or more of the operations may be changed, one or more of the operations may be omitted, and two or more of the operations may be performed in parallel or simultaneously without departing from the spirit and scope of the example embodiments described herein.

A memory device of one or more embodiments may include a plurality of memory banks, and a PIM block accessible to the plurality of memory banks, as described above.

At step 410, the PIM block may receive a plurality of operation instructions from a host. For example, the PIM block may store the plurality of operation instructions received from the host in a CRF.

At step 420, when there is an instruction indicating a predication operation among the plurality of operation instructions, a control circuit of the PIM block may instruct an ALU to execute the predication operation. For example, when a predication condition is x>10, the ALU may execute, as a CMP operation, an operation of subtracting 10 from x (e.g., x−10) and determine whether a result thereof is positive.

At step 430, a PRF of the PIM block may store a predicate value determined by the predication operation. The predicate value, which is a result of the predication operation, may be determined, for example, to be a bit value (e.g., 1) indicating “true” when the predication condition is satisfied and a bit value (e.g., 0) indicating “false” when the predication condition is not satisfied. In the example above where the predication condition is x>10, when the result of subtracting 10 from x is positive, the predicate value may be determined as a bit value (e.g., 1) corresponding to “true.” Conversely, when the result is not positive, the predicate value may be determined as a value (e.g., 0) corresponding to “false.” The PRF may store the predicate value transmitted from the ALU.

At step 440, the ALU of the PIM block may perform an operation according to a command signal translated by the control circuit based on the predicate value from an operation instruction (e.g., a predicated operation instruction) that depends on the predicate value among the plurality of operation instructions. For example, when the predicate value indicates a first state (e.g., true), the control circuit (e.g., a decoder) may translate an operation instruction (e.g., a predicated instruction) that depends on the predicate value into a command signal instructing the execution of a specific operation. The ALU may then perform the operation indicated by the command signal. For another example, when the predicate value indicates a second state (e.g., false), the control circuit (e.g., the decoder) may translate a predicated instruction into a command signal indicating NOP. The ALU may skip an operation according to such an NOP signal.

It is to be noted that an example where the predication flag field P is enabled (e.g., the predication condition) is primarily described herein, but examples are not limited thereto. In an example where the negative predication flag field NP is enabled, only true and false are reversely switched, and other operations may be similarly applied. For example, when the negative predication flag field NP is enabled, the predication condition may need to be false (e.g., p==false) for the negative predication condition to be true (e.g., !p==true), as described above. Therefore, when the negative predication flag field NP is enabled, the ALU may perform a specific operation in response to the predication condition p being false (e.g., !p==true) and skip the operation according to NOP in response to the predication condition p being true (e.g., !p==false).

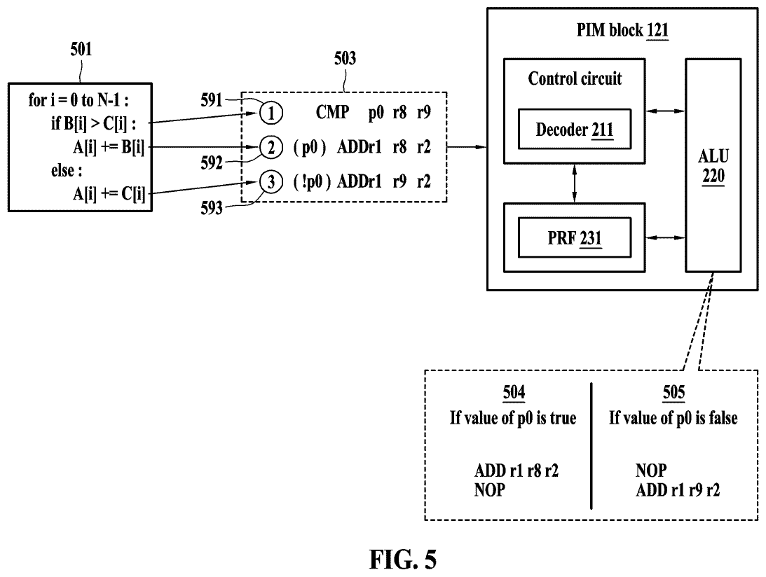

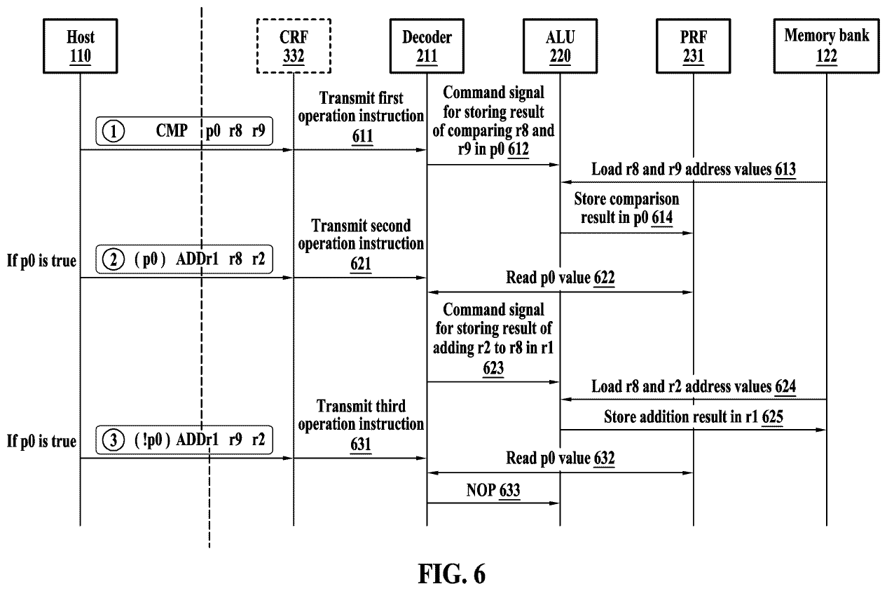

FIGS. 5 and 6 illustrate an example of how a PIM block processes a predicated operation according to one or more example embodiments.

In one or more embodiments, a decoder 211 of a control circuit may load a predicate value from a PRF 231 and translate a predicated instruction that depends on the predicate value into a command signal based on the predicate value. As an example, FIG. 5 illustrates an algorithm 501 that, when a value of an ith element B[i] of an array B is greater than a value of an ith element C[i] of an array C, adds the value of B[i] to a value of an ith element A[i] of an array A, and otherwise adds the value of C[i] to the value of A[i]. In this example, i may be an integer greater than or equal to 0 and less than N. A host may provide a memory device with three operation instructions 503 (e.g., a first operation instruction 591, a second operation instruction 592, and a third operation instruction 593) according to the algorithm 501. For example, the first operation instruction 591 may be an instruction that instructs storing, at index p0 of the PRF 231, a result of comparing (e.g., CMP) a value recorded at address r8 and a value recorded at address r9. In the example shown in FIG. 5, the value of the element B[i] may be stored at the address r8, and a value of an element C[j] may be stored at the address r9. The second operation instruction 592 may be an instruction that instructs adding the value (e.g., the value of B[i]) at the address r8 to a value at address r2 and storing a result therefrom at address r1 when the predicate value at the predicate address p0 is true. In this case, the address r1 may be a location at which the value of A[i] before the addition is stored, and the address r2 may be a location at which the value of A[i] after the addition is stored. The third operation instruction 593 may be an instruction that instructs adding the value (e.g., the value of C[i]) at the address r9 to the value at the address r2 and storing a result therefrom at the address r1 when the predicate value at the predicate address p0 is false. However, the preceding is provided merely as an example, and the algorithm described above is not limited to including only the three operation instructions, and the type or number of operation instructions may vary depending on the design.

In the example described above, the PIM block 121 may store the predicate value in the PRF 231 in response to the first operation instruction 591. The decoder 211 of the PIM block 121 may load, from the PRF 231, the predicate value to be referenced to, in response to the second operation instruction 592 and the third operation instruction 593.

The control circuit (e.g., the decoder 211 of the control circuit) may instruct an ALU 220 to perform at least one of an arithmetic operation or a logical operation corresponding to a predicated instruction, when a condition specified for performing the operation corresponding to the predicated instruction is true by the predicate value. The control circuit may also instruct the ALU 220 NOP for the predicated instruction, when the condition specified for performing the operation corresponding to the predicated instruction is false by the predicate value.

For example, in the example shown in FIG. 5, how the ALU 220 operates may vary depending on the predicate value. In a case 504 where the value of the predicate address p0 is true, the decoder 211 may translate the second operation instruction 592 into a command signal instructing adding (ADD) r8 to r2 and storing a result therefrom in r1 and provide the command signal to the ALU 220, and the decoder 211 may translate the third operation instruction 593 into a command signal indicating NOP and provide the command signal to the ALU 220.

In a case 505 where the value of the predicate address p0 is false, the decoder 211 may translate the second operation instruction 592 to a command signal indicating NOP and provide the command signal to the ALU 220, and the decoder 211 may translate the third operation instruction 593 into a command signal instructing adding (ADD) r9 to r2 and storing a result therefrom in r1 and provide the command signal to the ALU 220.

The decoder 211 may instruct different ALUs in parallel operations (e.g., a specific operation and NOP) in the respective cases 504 and 505 where the predicate value is true (e.g., 504) and false (e.g., 505). An example of the execution of the example shown in FIG. 5 in parallel is described in detail below with reference to FIG. 6.

In the example shown in FIG. 6, a host 110 may provide a first operation instruction (e.g., CMP p0 r8 r9) to a memory device of one or more embodiments. At step 611, the first operation instruction may be transmitted to a decoder 211. For example, a CRF 332 may store the first operation instruction received from the host 110, and the decoder 211 may read the first operation instruction.

At step 612, the decoder 211 may translate the first operation instruction into a first command signal. For example, the decoder 211 may instruct an ALU 220 the first command signal from the first operation command that instructs storing, at a predicate address p0, a value acquired by comparing a value corresponding to address r8 and a value corresponding to address r9, which are source operands.

At step 613, the ALU 220 may load the value of the address r8 and the value of the address r9 according to the first command signal. The ALU 220 may load the values of the addresses r8 and r9 of a memory bank 122. However, examples are not limited thereto, and at least one of the addresses r8 and r9 may indicate a location in a register file (e.g., a GRF) of a PIM block. The ALU 220 may determine whether a result of subtracting the value of the address r9 from the value of the address r8 is greater than zero (0) according to the CMP operation.

At step 614, the ALU 220 may store, at the predicate address p0, the comparison result value acquired as described above according to the first operation instruction. Therefore, the predicate value may be set. In the examples shown in FIGS. 5 and 6, subsequent operations may be determined according to the predicate value.

For example, FIG. 6 illustrates an example case where the predicate value (e.g., the value set at the predicate address p0) is true, for the simplicity of description.

The host 110 may transmit a second operation instruction (e.g., (p0) ADD r1 r8 r2) to the memory device. At step 621, the decoder 211 may receive the second operation instruction.

At step 622, the decoder 211 may read the predicate value from the PRF 231.

At step 623, the decoder 211 may translate the second operation instruction into a second command signal based on the predicate value. In the example shown in FIG. 6, when the predicate value is true, the decoder 211 may translate the second operation instruction into a command signal that instructs adding a value of r2 to the value of r8 and storing a result therefrom in r1. The decoder 211 may provide the second command signal to the ALU 220.

At step 624, the ALU 220 may load the values of the address r8 and the address r2 according to the second command signal. The ALU 220 may determine a result of adding the value of the address r8 and the value of the address r2.

At step 625, the ALU 220 may store an operation result (e.g., the result of the addition) at the address r1.

The host 110 may transmit a third operation instruction (e.g., (!p0) ADD r1 r9 r2) to the memory device. At step 631, the decoder 211 may receive the third operation instruction.

At step 632, the decoder 211 may read the predicate value from the PRF 231.

At step 633, the decoder 211 may translate the third operation instruction into a third command signal based on the predicate value. In the example shown in FIG. 6, when the predicate value is true, the decoder 211 may translate the third operation instruction into a command signal indicating NOP. The decoder 211 may provide the third command signal to the ALU 220. The ALU 220 may skip an operation according to the third command signal indicating NOP.

In the preceding example, the steps 621, 622, 623, 624, and 625 for the second operation instruction and the steps 631, 632, and 633 for the third operation instruction may be executed in parallel. For example, the decoder 211 may provide, in parallel, the second command signal corresponding to the second operation instruction to a first ALU among a plurality of ALUs and the third command signal corresponding to the third operation instruction to a second ALU among the plurality of ALUs. In the example shown in FIG. 6, when predication conditions of the second command signal and the third command signal are in a logical negation relationship with each other, either of the first ALU and the second ALU may skip an operation according to the NOP command signal. The remaining one between the first ALU and the second ALU may perform a specific operation.

In addition, in the example shown in FIG. 6, a case where the predicate value indicates true is described, but how the first ALU and the second ALU perform an operation may be reversed in a case where the predicate value indicates false. For example, when the predicate value indicates false, the first ALU may skip an operation according to the command signal indicating NOP, and the second ALU may perform the specific operation. Therefore, the PIM block may instruct the plurality of ALUs to perform operations in parallel according to operation instructions independently of a predicate value (e.g., independent of whether it is true or false).

Accordingly, the host 110 may instruct the memory device to perform a predicated instruction without having to handle a predication operate or a predicate value. The memory device of one or more embodiments may perform the predication operation in the PIM block itself without having to report the predicate value to the host 110 and perform the predicated operation according to the result, thereby improving performance of the computing system 100 on which the PIM block is implemented.

FIG. 7 illustrates an example of how a PIM block processes a predication operation of a graph traversal algorithm according to one or more example embodiments.

Some operations in an execution flow may be executed when a conditional statement is satisfied and may not be executed when the conditional statement is not satisfied. FIG. 7 illustrates an example execution flow in a case where a conditional statement is included in a loop. Whether the conditional statement is satisfied may be determined based on a predicate value and a predication condition (e.g., positive or negative) of each predicated instruction, as described above.

In one or more embodiments, a plurality of operation instructions may include an instruction for checking a conditional statement included in a loop and a predicated instruction associated with the conditional statement. The instruction for checking the conditional statement may refer to an instruction that instructs the execution of a predication operation. The predication operation may be an operation of generating a predicate value to be used to determine whether the conditional statement is satisfied, as described above. The predicated instruction may refer to an instruction that indicates an operation to be performed or not performed based on a predicate value.

A host may transmit, to a memory device, a predication operation instruction corresponding to the conditional statement. For example, a control circuit may instruct an ALU to execute a predication operation corresponding to the conditional statement. The ALU may store, in a PRF, a predicate value (e.g., a predicate value corresponding to the specified conditional statement) acquired through the predication operation.

The control circuit may instruct the ALU whether to perform an operation corresponding to a predicated instruction based on a predicate value according to the checking of the conditional statement. Depending on the predicate value determined by the predication operation, a specific operation may be or may not be executed. For example, as described above with reference to FIGS. 4 through 6, when the predicate value is true, the control circuit may instruct the execution of an operation that follows a predication condition (e.g., a positive predication condition) among predicated operations and may instruct skipping an operation that follows a negative predication condition (e.g., NOP).

In one or more embodiments, a PIM block may load, from the same memory bank, at least one of values for the checking of the conditional statement and the operation corresponding the predicated instruction. For example, a value (e.g., an operand of a predication operation) for a predication operation specified for checking the conditional statement, a predicate value, and a value (e.g., an operand of an arithmetic logic operation) for a predicated operation that depend on the predicate value generated by the predication may be stored at locations (e.g., a memory bank or a register file) that may be accessible by the same PIM block. The value for the predication operation and the value for the operation corresponding to the predicated instruction may be stored in the same memory bank or in the same register file. Further, the values described above may be distributed and stored in memory banks and register files accessible by the same PIM block. Therefore, the PIM block may itself perform the predication operation and the operation corresponding to the predicated instruction according to an operation instruction received from the host. The host may instruct a single PIM block to perform a series of operations (e.g., the predication operation and the operation corresponding to the predicated instruction that depends on a result of the predication operation) without having to instruct different PIM blocks (e.g., 721).

The memory device may also have a plurality of PIM blocks 721. The plurality of PIM blocks 721 may perform operations in parallel for their respective iterations in a loop. For example, a location where values used for a predication operation and/or an operation corresponding to a predicated instruction in one iteration of a loop are stored may be different from a location where values used in another iteration are stored. That is, for example, values for an operation in a first iteration may be stored at a location (e.g., a memory bank and/or register file) accessible by a first PIM block, and values for an operation in a second iteration may be stored at a location accessible by a second PIM block. In a case where values and operations used in each iteration are independent of values and operations used in another iteration, the memory device (e.g., the control circuit) may instruct the plurality of PIM blocks 721 to perform the operations of their respective iterations in parallel, independent of the execution in another PIM block. Therefore, operations in an iteration may be performed by a single PIM block in batches, and the iterations may be processed respectively by the corresponding PIM blocks 721. The execution of an operation based on a conditional statement in a loop and the parallel execution of multiple iterations are described with reference to an example graph traversal shown in FIG. 7.

A graph may represent a data structure including a plurality of nodes connected by one or more edges. In a pre-generated graph, a connection between nodes (e.g., whether two nodes are adjacent) may be given, but a distance between the nodes may not be given. A computing system (e.g., the host and/or the memory device) may determine (or determine) a distance between nodes (e.g., a distance from a source node to each node) by graph traversal. A distance between two nodes may be represented based on an edge that is to be traversed from one of the two nodes to reach the other. For example, the distance between the two nodes may be the number of edges that are to be traversed from one of the nodes to reach the other. However, for the simplicity of description, an undirected graph is provided herein as an example, but examples are not limited thereto. A directed graph or a weighted graph may also be used. In the weighted graph in which a weight is set for an edge, a distance between two nodes may be determined as a weighted sum based on the number of edges and weights set for the edges.

The graph traversal may be implemented with various algorithms. FIG. 7 illustrates, as an example, code 700 performing a breadth-first search (BFS). The computing system may use the BFS to sequentially visit (or traverse) nodes, starting from a source node, and may thereby determine a distance from the source node to each of the nodes. For example, the BFS may add, (incrementally) by a predetermined value (e.g., 1), a distance from the source node to a target node (e.g., an ith node in the loop of FIG. 7) until the two nodes are determined to be near each other.

For example, each variable and/or data used in the execution flow shown in FIG. 7 is as follows. “N” may denote the number of nodes included in the graph, which may be an integer greater than or equal to 2. “start” may denote a value indicative of an index of a node that is the start of the traversal, which may be a value greater than or equal to zero (0) and less than N. For example, the host may select any one of a plurality of nodes included in the graph as the source node, in response to an input (e.g., a user input). In this case, a source index indicative of the selected source node may be determined.

“A” may be an adjacency matrix indicative of an adjacency relationship between nodes. It is to be noted that information (e.g., the adjacency matrix) indicating the adjacency relationship between the nodes may be generated in advance. In the adjacency matrix A, when a jth node and an ith node are adjacent to each other, A[j][i]=1 may be set, where i and j may each be an integer greater than or equal to zero (0) and less than N. In a case of reaching the ith node from the jth node without traversing any additional nodes between the jth node and the ith node, the jth node and the ith node may be determined to be adjacent to each other. In a case where the two nodes are not adjacent to each other, A[j][i]=0 may be set.

“visited” may denote array data including values indicating whether N nodes have been visited based on the source node. “visited[i]” may have a value indicating whether the ith node in the graph has been visited from the source node. In this case, initial values of the array “visited” may be set to “FALSE.”

“distance” may denote array data including values indicative of a distance from the source node to each node. “distance[i]” may have a value indicative of a distance from the ith node in the graph from the source node. In this case, initial values of the array “distance” may be set to zero (0).

“queue” may denote array data indicative of an order (or sequence) of nodes selected as a reference node in the BFS. An initial value of the array “queue” may be the source node (e.g., the source node represented as “start”) that is the start of the traversal. When the distance traversal relative to the source node is completed, another node may be selected as a subsequent reference node.

In the BFS traversal based on a specific source node (e.g., the start node), the computing system may: 1) update a distance while traversing each node included in the graph at each iteration, and 2) update a queue with nodes that are adjacent to a selected source node (e.g., a jth node) in a corresponding iteration. When updating the distance, when a node being traversed (e.g., a current node) has not yet been visited (e.g., visited[i]==FALSE), the computing system may add 1 to the distance (e.g., distance[j]) from the source node to that node. When a node being traversed (e.g., the current node) and an ith node are adjacent to each other, the computing system may record a visit to the ith node. For example, when an adjacency value (e.g., A[current_node][i]) between the jth node and the ith node is true, the computing system may set, to be true, a value (e.g., visited[i]) indicating whether the ith node has been visited. After the traversal of the jth node, which is the current reference node, is completed, a subsequent reference node may be selected based on the updated queue, as described in examples later. When visited[i]=TRUE is set in the previous traversal of the jth node, the distance update may be skipped, starting from the traversal of the subsequent reference node.

It is to be noted that, when updating the queue, the subsequent reference node may be selected based on the updated queue after the traversal on the current reference node is completed. In the example of FIG. 7, an index indicative of the reference node may be represented by “j.” For example, when a traversal with an arbitrary source node as the current reference node is completed, a different node may be selected as the subsequent reference node based on a traversal order. For example, in a graph including node 0 connected to node 1 and node 2 (e.g., node 1←0→node 2), the computing system may visit node 0, then node 1, and then node 2. The computing system may update the queue by adding node 0 and subsequent nodes 1 and 2 to the queue. When the traversal of node 0, which is the current reference node, is completed, node 1 may be selected as the subsequent reference node. When the traversal of node 1 is completed, node 2 may then be selected as the reference node.

The distance update in the BFS may include a predicated execution. For example, referring to an example code for implementing the BFS shown in FIG. 7, there are (1) a first predication operation to determine whether visited[i] is FALSE, (2) a first predicated operation to add 1 to distance[i] when visited[i]==FALSE, (3) a second predication operation to determine whether A[current_node][i] is TRUE, and (4) a second predicated operation to set TRUE for visited[i] when A[current_node][i]==TRUE. In any iteration according to a loop for the BFS, the first predication operation, the first predicated operation, the second predication operation, and the second predicated operation may be performed by a single PIM block as described below.

The memory device may include a plurality of PIM blocks 721 and M memory banks 722. Each memory block may be accessible to one or more memory banks. FIG. 7 illustrates an example where a first PIM block 721-1 is accessible to a first bank 722-1 and a second PIM block 721-9 is accessible to a second bank 722-9. In this example, element values of the array “visited” indicating whether a visit has occurred, the array “distance,” and the adjacency array A may be distributed and stored in the plurality of memory banks 722. For example, values to be processed by a corresponding PIM block in each iteration may be stored at a location (e.g., the same memory bank) accessible by that PIM block.

Referring to FIG. 7, an element value 751 (e.g., visited[0])of an array 750 indicating whether a visit has occurred, an element value 771 (e.g., distance[0]) of a distance array 770, and an element value 791 (e.g., A[1][0]) of an adjacency array 790 (e.g., adjacency matrix), which are used in an iteration, may be stored in the same memory bank, e.g., BANK₀ (e.g., the first bank 722-1). In the first predication operation, the first PIM block 721-1 may determine whether visited[0] is FALSE to generate a first predicate value. In the first predicated operation, the first PIM block 721-1 may perform distance[i]+=1 when visited[0]==FALSE, and otherwise skip an operation by NOP. Similarly, in the second predication operation, the first PIM block 721-1 may determine whether A[current_node][i]==TRUE to generate a second predicate value. In the second predicated operation, the first PIM block 721-1 may perform visited[i]=TRUE when A[current_node] [i]==TRUE, and otherwise skip an operation by NOP.

In addition, when performing, by the first PIM block 721-1, the predication operations and the predicated operations corresponding to any one iteration among a plurality of iterations according to a loop, the second PIM block 721-9 may also perform operations in an iteration assigned thereto, in parallel. It is to be noted that the example where the operations (e.g., the first predication operation, the first predicated operation, the second predication operation, and the second predicated operation) in one iteration are performed by each PIM block is illustrated in FIG. 7 for ease of understanding, but examples are not limited thereto. As described above with reference to FIGS. 4 through 6, a plurality of ALUs in the same PIM block may perform the operations in parallel. Therefore, the plurality of PIM blocks 721 (e.g., the ALUs in the PIM blocks 721) respectively corresponding to a plurality of iterations (e.g., N iterations) may each perform a predication operation and a predicated operation assigned to each in parallel. That is, the operations corresponding to the N iterations in the loop shown in FIG. 7 may be performed in parallel by the PIM blocks 721 of the memory device, instead of being performed sequentially.

In one or more embodiments, when a predicate value is stored in a PIM block, the memory device may determine, simultaneously and/or in parallel, all nodes of the graph via the PIM blocks 721. In one or more embodiments, when the memory device does not transmit a predicate value to the host or receive a command signal determined by the predicate value from the host, the overhead that may be incurred by communication between the host and the memory device may be inhibited even when the number of nodes in the graph increases.

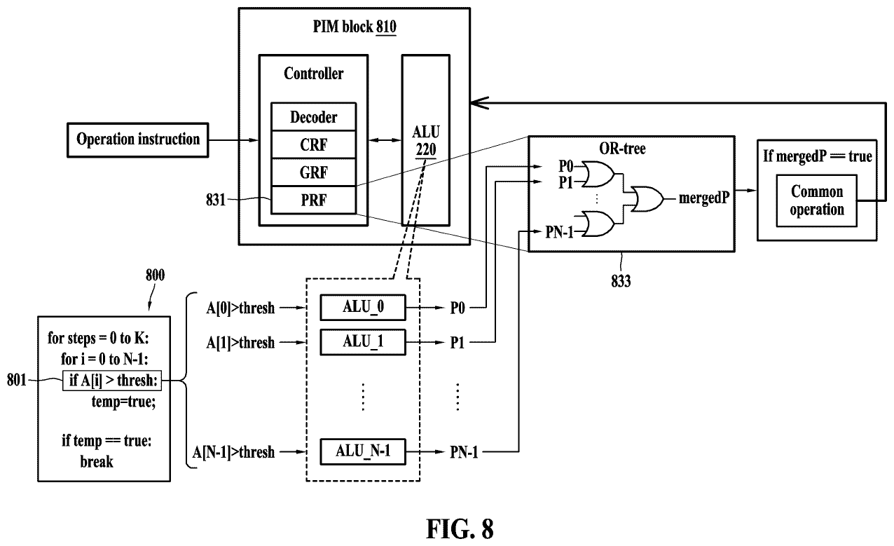

FIG. 8 illustrates an example of how a PIM block determines and logically merges predicate values in parallel via a plurality of ALUs and performs a common operation based on a merged predicate value, according to one or more example embodiments.

In one or more embodiments, a PIM block 810 may have a plurality of ALUs including an ALU 220. A control circuit may acquire a plurality of predicate values by performing, via the plurality of ALUs, a conditional operation (e.g., a predication operation) in each iteration according to a loop. The control circuit may instruct the plurality of ALUs to perform a common operation determined based on a logically merged value (e.g., a merged predicate value) of the plurality of predicate values. In this case, merging the plurality of predicate values may be performed based on at least one of a logical conjunction (e.g., logical AND) and a logical disjunction (e.g., logical OR) of the plurality of predicate values. By performing such a unified common operation determined based on the merged predicate value described above, the PIM block 810 may perform a complex execution flow having multiple conditions by a more simplified operation.

For example, the control circuit may instruct N ALUs to determine predicate values in parallel for N conditional statements in N iterations. That is, in this case, N predicate values may be determined in parallel. The N predicate values determined in parallel may be merged by a predicate tree circuit 833. The predicate tree circuit 833 may output a logically merged value from a plurality of predicate values. In this example, the predicate tree circuit 833 may be a tree-structured logical operation circuit that receives the N predicate values and performs logical operations on at least two of the received N predicate values in a hierarchically connected manner.

For example, although a PRF 831 may include the predicate tree circuit 833, examples are not limited thereto. In the example shown in FIG. 8, the predicate tree circuit 833 may be an OR tree and output, as the merged predicate value, a result of the logical disjunction (logical OR) of the N predicate values.

However, the merging of predicate values is not limited to the preceding example. The PIM block 810 may further instruct the ALUs 220 to perform a logical operation (e.g., an AND operation or an OR operation) to merge the predicate values. The merged predicate value may be managed as a value separate from operation instructions and stored in a register file or memory bank. Alternatively, associated predication operation instructions may have a common merged predicate value in an additional predication merge bit field. For example, a last bit field of a predication operation instruction may be the predication merge bit field. Previously, CMP p0 r8 r9 has been provided as an example of the predication operation instruction, but the predication operation instruction may also be CMP p0 r8 r9 1. In this case, “1” added at the end may be the merged predicate value, which is the result of the logical operation of the predicate values.

The merged predicate value described above may be useful for a dynamic loop. The dynamic loop may refer to a loop that escapes the loop when a specific condition is satisfied. Referring to a dynamic loop 800 shown in FIG. 8, there are 0 through N−1 iterations inside a loop of 0 through K, where K is an integer greater than or equal to zero (0). According to a conditional statement 801 in an inner loop, when A[i] >thresh, temp=true may be set. When “temp” is set to “true,” a computing device may escape an outer loop (e.g., iterations from 0 to K). That is, when any A[i] of the N iterations is greater than “thresh,” the computing device may escape the outer loop by setting temp=true.

The PIM block 810 of the memory device may perform in parallel predication operations of the N iterations via the plurality of ALUs 220, as described above. For ease of understanding, FIG. 8 illustrates an example where N ALUs 220 (e.g., ALU_0, ALU_1, . . . , and ALU_N−1) generate N predicate values (e.g., P0, P1, . . . , and PN−1), respectively. The predicate tree circuit 833 of the PRF 831 may output a merged predicate value (e.g., merged) as a result of merging the N predicate values. The PIM block 810 may perform a common operation (e.g., escaping the outer loop) when merged==true. The PIM block 810 may instruct the N ALUs 220 respectively corresponding to the N iterations to perform the common operation. Therefore, the PIM block 810 may perform operations in the dynamic loop, in parallel and in batch, with the merged predicate value based on predication operations in the plurality of iterations. In the example shown in FIG. 8, the N predicate values corresponding to the N iterations may be determined in parallel, and a computing system (e.g., the PIM block 810) may thus escape the dynamic loop in only a time that is used for a single iteration, rather than having to wait an amount of time by a factor of N times of the time used for the single iteration.

The result (e.g., the merged predicate value) of the logical merging operation described above may be transmitted to the host. In this case, the host may instruct the PIM block 810 to perform the common operation (e.g., the escaping operation such as “break”). This may require less energy and time than when all predicate values are transmitted to the host. Although the preceding example describes the merging of predicate values in a single PIM block 810, examples are not limited thereto. For example, a plurality of predicate values may be merged by a plurality of PIM blocks 810, and in this case, a merged predicate value may be shared by the respective PIM blocks 810. Additionally, the predicate values determined by the respective PIM blocks 810 or ALUs 220 may be stored in corresponding PRFs 831. In this case, depending on the design, whether a value indicating “true” or a value indicating “false” in a PIM block 810 or ALU 220 may need to be determined, and thus the predicate values may be stored separately.

The dynamic loop may be used for an escape in a case where there is no node to be selected subsequently after a traversal of a specific reference node is completed in the BFS described above with reference to FIG. 7. As another example, the dynamic loop may correspond to a process of determining a threshold value in k-means clustering, which is described with reference to Table 1 below, for example.

TABLE 1

```
K-clustering algorithm pseudocode
Params: c_new: new centroid, c_old: old centroid
c_new = random_centroids( )
c_old = None
while c_new != c_old:
  c_old = c_new
  for point in dataset do:
    closest_INT_MAX
    for i=0 to length(c_new) do:
      d = distance(point, c_new[i])
      if d<closest:
        closest = d
        set_label(point, i)
    for i=0 to length(c_new) do:
      c_dataset[ ]
      for point in dataset do:
        if label(point) == i:
          c_dataset.append(point)
        c_new[i] = find_new_centroid(c_dataset)
```

The k-clustering algorithm may be a typical machine learning algorithm for clustering a large number of data points. In the code shown in Table 1 above, when no progress is made in finding a new centroid within a “while c_new !=c_old, while” statement, this may indicate a condition that terminates a loop, and thus this pseudocode above may be a dynamic loop. In a second “for” statement of the above code, c_new[i]=find_new_centroid(c_dataset) may be performed in parallel by a PIM block (or an ALU in the PIM block) for a plurality of “i”s (e.g., all “i”s) as described above. The results of the comparison between “c_new” values and “c_old” values as many as the number of “length(c_new)” may be acquired as predicate values. A result of logically merging these predicate values may be a value indicating whether all the “c_new” values are equal to the “c_old” values. When all the “c_new” values and the “c_old” values are the same, the dynamic loop by “while” may be terminated. It is to be noted that operations in the “for” statement may process data in parallel as described above with reference to FIGS. 1 through 8. Although not explicitly expressed in the pseudocode above, elementwise operations (e.g., elementwise GeMV and elementwise dot) may be performed in a distance function at “d=distance(point, c_new[i]).” As described above, “if” statements may correspond to predication operations, and operations inside an “if” statement may be predicated operations.

The memory device of embodiments of the present disclosure may perform, in parallel, predication operations and predicated operations of an algorithm in which a primary predicated operation is a dot product and/or value comparison. For example, the memory device may efficiently process, in parallel, operations such as k-means clustering in machine learning, and database select (SELECT), word count, Hamming distance, and R-tree query in data analytics. The memory device may also efficiently process, in parallel, operations such as BFS and graph shortest path in graph computation, and k-mers count in biotechnology.

The computing systems, hosts, memory devices, PIM blocks, memory banks, control circuits, ALUs, register files, PRFs, decoders, interfaces, FP16 multipliers, FP16 adders, CRFs, GRFs, SRFs, predicate tree circuits, computing system 100, host 110, memory device 120, PIM block 121, memory bank 122, control circuit 210, ALU 220, register files 230, PRF 231, decoder 211, PIM block 300, interface 340, FP16 multiplier 321, FP16 adder 322, CRF 332, GRF 333, SRF 334, PIM block 810, and predicate tree circuit 833 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A memory device, comprising:
a plurality of memory banks; and
a processing-in-memory (PIM) block accessible to the plurality of memory banks,
wherein the PIM block comprises:
a control circuit configured to receive a plurality of operation instructions from a host and, in response to a predicated instruction indicating a predication operation among the plurality of operation instructions, instruct an arithmetic logic unit (ALU) to perform the predication operation;
a predicate register file (PRF) configured to store therein a predicate value determined by the predication operation; and
the ALU configured to perform an operation according to a command signal translated by the control circuit based on the predicate value from an operation instruction that depends on the predicate value among the plurality of operation instructions.

2. The memory device of claim 1, wherein, for the instructing of the ALU to perform the predication operation, the control circuit comprises a decoder configured to:
load the predicate value from the PRF; and
translate a predicated instruction that depends on the predicate value into the command signal based on the predicate value.

3. The memory device of claim 1, wherein, for the instructing of the ALU to perform the predication operation, the control circuit is configured to, in response to a condition specified for performing an operation corresponding to the predicated instruction being true by the predicate value, instruct the ALU to perform either one or both of an arithmetic operation and a logical operation corresponding to the predicated instruction.

4. The memory device of claim 1, wherein, for the of instructing the ALU to perform the predication operation, the control circuit is configured to, in response to a condition specified for performing an operation corresponding to the predicated instruction being false by the predicate value, instruct the ALU no operation (NOP) in response to the predicated instruction.

5. The memory device of claim 1, wherein
the plurality of operation instructions comprises an instruction for checking a conditional statement comprised in a loop and a predicated instruction associated with the conditional statement, and
for the instructing of the ALU to perform the predication operation, the control circuit is configured to, based on a predicate value from the checking of the conditional statement, instruct the ALU whether to perform an operation corresponding to the predicated instruction.

6. The memory device of claim 5, wherein, for the performing of the operation according to the command signal by the ALU, the PIM block is configured to load, from the same memory bank, one or more values for the checking of the conditional statement and the operation corresponding to the predicated instruction.

7. The memory device of claim 5, comprising:
a plurality of PIM blocks comprising the PIM block,
wherein, for the performing of the operation according to the command signal by the ALU, the plurality of PIM blocks is configured to perform, in parallel, operations according to respective iterations for which the plurality of PIM blocks are configured to perform respectively in the loop.

8. The memory device of claim 1, wherein
the PIM block has a plurality of ALUs comprising the ALU, and
the control circuit is configured to:
acquire a plurality of predicate values by performing a conditional operation of each iteration in the loop by each of the plurality of ALUs; and
instruct the plurality of ALUs to perform a common operation determined based on a logically merged value of the plurality of predicate values.

9. The memory device of claim 8, wherein the control circuit is configured to, for n conditional statements in n iterations, instruct n ALUs to determine predicate values in parallel.

10. The memory device of claim 8, wherein the PRF comprises a predicate tree circuit configured to output the logically merged value from the plurality of predicate values.

11. An operating method of a memory device, comprising:
receiving a plurality of operation instructions from a host;
in response to a predicated instruction indicating a predication operation among the plurality of operation instructions, instructing an arithmetic logic unit (ALU) to perform the predication operation;
storing, in a predicate register file (PRF), a predicate value determined by the predication operation; and
performing, by the ALU, an operation according to a command signal translated based on the predicate value from an operation instruction that depends on the predicate value among the plurality of operation instructions.

12. The operating method of claim 11, wherein the instructing of the ALU to perform the predication operation comprises:
loading the predicate value from the PRF; and
translating a predicated instruction that depends on the predicate value into the command signal based on the predicate value.

13. The operating method of claim 11, wherein the instructing of the ALU to perform the predication operation comprises, in response to a condition specified for performing an operation corresponding to the predicated instruction being true by the predicate value, instructing the ALU to perform either one or both of an arithmetic operation and a logical operation corresponding to the predicated instruction.

14. The operating method of claim 11, wherein the instructing of the ALU to perform the predication operation comprises, in response to a condition specified for performing an operation corresponding to the predicated instruction being false by the predicate value, instructing the ALU no operation (NOP) in response to the predicated instruction.

15. The operating method of claim 11, wherein
the plurality of operation instructions comprises an instruction for checking a conditional statement comprised in a loop and a predicated instruction associated with the conditional statement, and
the instructing of the ALU to perform the predication operation comprises instructing the ALU to perform an operation corresponding to the predicated instruction based on a predicate value from the checking of the conditional statement.

16. The operating method of claim 15, wherein the performing of the operation according to the command signal by the ALU comprises loading, from the same memory bank, one or more values for checking the conditional statement and the operation corresponding to the predicated instruction.

17. The operating method of claim 15, wherein the performing of the operation according to the command signal by the ALU comprises performing, by a plurality of processing-in-memory (PIM) blocks, operations, in parallel, according to respective iterations for which the PIM blocks are configured to perform respectively in the loop.

18. The operating method of claim 11, wherein
a PIM block of the memory device has a plurality of ALUs comprising the ALU, and
the instructing of the ALU to perform the predication operation comprises:
acquiring a plurality of predicate values by performing a conditional operation of each iteration according to a loop via each of the plurality of ALUs; and
instructing the plurality of ALUs to perform a common operation determined based on a logically merged value of the plurality of predicate values.

19. The operating method of claim 18, wherein the instructing of the ALU to perform the predication operation comprises, for n conditional statements in n iterations, instructing n ALUs to determine predicate values in parallel.

20. A memory device, comprising:
a processing-in-memory (PIM) block comprising a control circuit configured to:
in response to a predicated instruction indicating a predication operation among a plurality of operation instructions received from a host, generate a first instruction instructing an arithmetic logic unit (ALU) to perform either one or both of an arithmetic operation and a logical operation corresponding to the predicated instruction, and generate a second instruction instructing the ALU no operation (NOP) in response to the predicated instruction; and
instruct the ALU based on either the first instruction or the second instruction, based whether a condition specified for performing an operation corresponding to the predicated instruction is true by a predicate value determined by the predication operation; and
the ALU configured to perform an operation according to the instructing of the PIM block.
